(19) United States
(12) Patent Application Publication
(10) Pub. No.: US 2017/0167185 A1
(43) Pub. Date: Jun. 15, 2017

(54) WINDOW ASSEMBLY SECUREMENT

(71) Applicant: Anthonie BOER, Campbellville (CA)

(72) Inventor: Anthonie BOER, Campbellville (CA)

(21) Appl. No.: 15/374,537

(22) Filed: Dec. 9, 2016

Related U.S. Application Data
(60) Provisional application No. 62/266,041, filed on Dec. 11, 2015.

(51) Int. Cl. E06B 1/36; E06B 3/263; E06B 1/18; E06B 3/58; E06B 1/32

(52) U.S. Cl. CPC E06B 1/36; E06B 3/58; E06B 1/32; E06B 1/18; E06B 3/263

(57) ABSTRACT

A window assembly includes an inside frame, and outside frame, a glazing panel and a set of connectors that serve to seat, or positively locate, the glazing panel relative to one of the frames, and also positively to locate the inside and outside frames relative to each other. The members of the frames and the connectors may all be extrusions. The connector may have non-releasing, one-way engagement fittings that snap fit together with mating fittings on the frames. The frames may be made of a metal such as aluminum. The connectors may be made of a thermal insulator, such as a plastic of other composite material, that may tend not to form a thermal bridge between the inner and outer frames.

### CROSS-REFERENCE TO RELATED APPLICATIONS

This application claims the benefit of the filing date of U.S. Provisional Application No. 62/266,041 filed Dec. 11, 2015 entitled Window Assembly Securement, the content of which is incorporated herein by reference.

### FIELD OF THE INVENTION

This invention relates to the field of doors having windows.

### BACKGROUND OF THE INVENTION

In window assemblies the inside and outside framing members may be made of aluminum, often in the form of extrusions. It may be that an insulating member is, or insulating members are, mounted between the inner and outer aluminum members, with the object of reducing thermal conduction heat loss through the structure. It may be that such an insulating connector may also facilitate or improve assembly of the window structure, whether in terms of reduction of effort, repeatability, or quality of finished product.

### SUMMARY OF THE INVENTION

In an aspect of the invention there is a window assembly securement or fitting or connector. It has a connector body having a first end and a second end. The first end has a first frame engagement by which said connector body. The second end has a second frame engagement. The connector body has a first index, the first index defining an abutment against which to locate a glazing panel such as a window pane, or window glass, the index thereby fixing the position of the window pane relative to the second frame.

In a feature of that aspect of the invention, the body has a second index. The second index is mounted to the first end. The second index defines an abutment to seat against supporting structure to which the window assembly is mounted, the second index thereby fixing the position of the window relative to the supporting wall structure and hence also relative to the second frame on assembly. In another feature, the securement is a thermal insulator. In another feature, at least one of the first frame engagement and the second frame engagement is a one-way motion catch. In another feature, the first frame engagement is a one-way catch and the second frame engagement is a one-way catch. In another feature, the securement has a fastener accommodation passing therethrough. In still another feature, the securement is an extrusion. In still another feature, at least one of the first frame engagement and the second frame engagement is a spring biased deflection member. In another feature, the connector is made of a material having a co-efficient of thermal conductivity, k, that is less than 1 W/mK.

In another aspect of the invention, there is a window assembly. It has a first window frame member; a second window frame member; and a connector. The connector has a first end and a second end. The first widow frame member has a first fitting, the first fitting being matingly engageable with the first end of the connector. The second window frame member has a second fitting, the second fitting being matingly engageable with the second end of the connector. The connector is made of a thermal insulator material. When assembled the connector is positioned between the first and second frame members, and the first and second frame members bracket a window pane.

In a feature of that aspect of the invention, the first and second window frame members are formed of material that is more highly thermally conductive than the thermal insulator material of the connector. In another feature, at least one of the first and second window frame members is an extrusion. In another feature, at least one of the window frame members is made of aluminum. In still another feature, at least one of the window frame members has a wing that, on installation, conceals a margin of the window pane. In a further feature, the first window frame member and the second window frame member have the same cross-section.

In another feature, the connector has a first index. It defines an abutment against which to seat the window pane. The abutment is opposed to the second window frame member, whereby the window pane is located between the first index and the second window frame member. In yet another feature, the first window frame assembly has a first wing, and the second window frame assembly has a second wing. On assembly the first wing is faced to oppose the second wing, and the window pane is captured between the first and second wings of the first and second frames respectively. In another feature, on assembly, the first wing of the first window frame member and the first index are positioned flush with each other. In still another feature, the connector has a first index. The first index defines an abutment. On assembly, the abutment stands in opposition to the second frame member whereby the first frame member is fixedly located relative to the connector.

In a still further feature, the connector has a second index, the second index defines an abutment; and, on assembly, the abutment of the second index stands in opposition to the second frame member whereby the second frame member is positioned relative to the connector. In still another feature, the window assembly is one in which at least one of (a) the first frame member and the first end of the connector have mutually engaging end fittings, the end fittings being male on one hand, and female on the other, and being one-way spring-biased snap-fit on assembly; (b) the second frame member and the second end of the connector have mutually engaging end fittings, the end fittings being male on one hand, and female on the other, and being one-way spring-biased snap-fit on assembly. In still yet another further feature, the end fitting of the second window frame connector has flights for engagement of a threaded fastener; and the connector accommodates the passage of a threaded fastener therethrough to engage the flights, such engagement causing the second end fitting of the connector and the end fitting of the second window frame member to bind.

In another aspect of the invention there is any combination of any of the features of any one of embodiments shown or described herein, in combination with the features of any other embodiment, except to the extent those features are mutually exclusive. In another aspect of the invention, there is any apparatus substantially as shown or described herein, in whole or in part.

### BRIEF DESCRIPTION OF THE DRAWINGS

These aspects and other features of the invention can be understood with the aid of the following illustrations of a number of exemplary, and non-limiting, embodiments of the principles of the invention in which:

FIG. 1a shows a perspective view of a window assembly;

FIG. 1b shows a front view of the window assembly of FIG. 1a;

FIG. 1c shows a vertical section of the window assembly of FIG. 1a;

FIG. 1d shows a horizontal section of the window assembly of FIG. 1a;

FIG. 2 is a sectioned perspective view of the window assembly of FIG. 1a;

FIG. 3 is a cross-section of the window assembly of FIG. 1a; and

FIG. 4 is an enlarged detail, in cross-section of elements of the window assembly of FIG. 3.

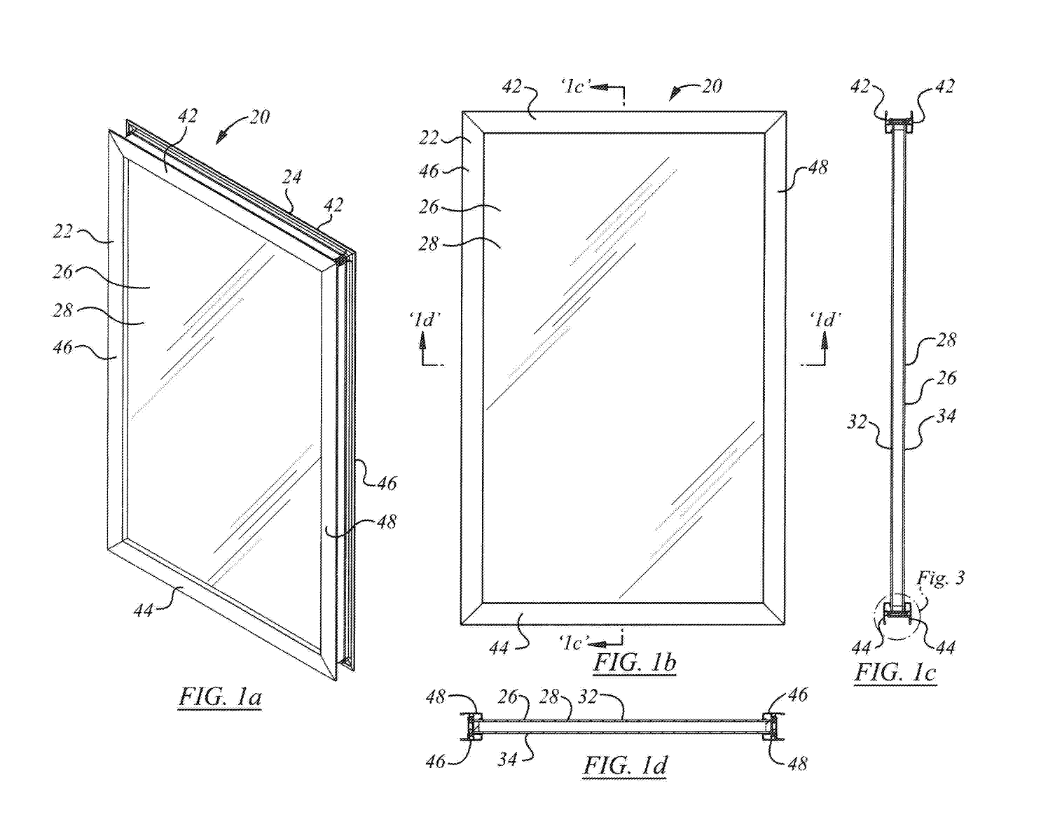

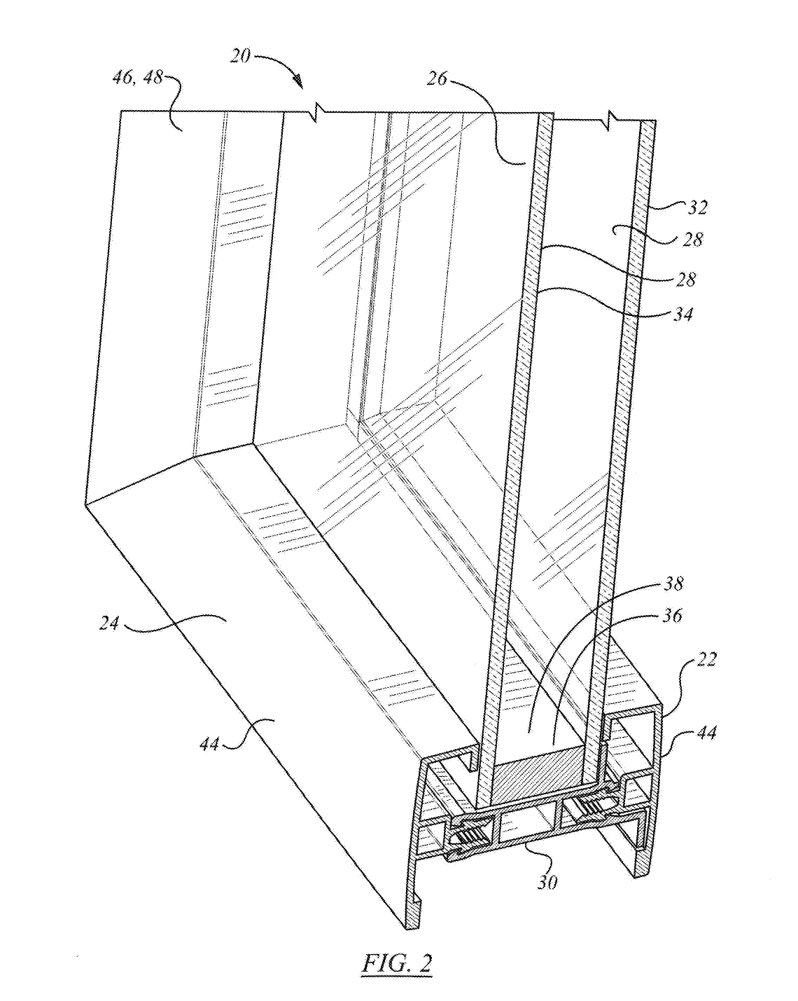

### DETAILED DESCRIPTION

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings may be understood to be to scale and in proportion unless otherwise noted. The wording used herein is intended to include both singular and plural where such would be understood, and to include synonyms or analogous terminology to the terminology used, and to include equivalents thereof in English or in any language into which this specification may be translated, without being limited to specific words or phrases.

For the purposes of this description, it may be that a Cartesian frame of reference may be employed. In such a frame of reference, the long, or largest, dimension of an object may be considered to extend in the direction of the x-axis, the base of the article, where substantially planar, may be considered to extend in an x-y plane, and the height of the article may be measured in the vertical, or y-direction. Accordingly, the width of the window assembly described herein may be arbitrarily designated as the x-direction; and the height may be arbitrarily designated as the y-direction. The through-thickness is then the z-direction. Unless noted otherwise, the terms “inside” and “outside”, “inwardly” and “outwardly”, refer to location or orientation relative to the window. In this description, when an item, or structure, or wall, is indicated as being insulated, such term is understood to mean that the wall has a layer of insulation. In this specification, The commonly used engineering terms “proud”, “flush” and “shy” may be used to denote items that, respectively, protrude beyond an adjacent element, are level with an adjacent element, or do not extend as far as an adjacent element, the terms corresponding conceptually to the conditions of “greater than”, “equal to” and “less than”.

In this specification a distinction is made between materials that are thermal conductors and thermal insulators. In general, the thermal conductors may be thought of as materials such as metals, such as steel, stainless steel, copper sheathing, mild steel flashing, whether galvanized or otherwise, or aluminum sheeting or aluminum extrusions, painted or otherwise. The insulators may be thought of as materials such as wood, particle board, oriented strand board, composites, whether fiber reinforced or otherwise, and plastics, whether fiber reinforced or otherwise. Plastics may have a thermal conductivity of, typically, 0.2-0.25 W/mK; softwood may have a cross-grain thermal conductivity of about 0.15 W/mK. By contrast, mild steel has a thermal conductivity of perhaps 50 W/mK; stainless steel of 12 W/mK; aluminum of up to 210 W/mK. As the difference between insulators and conductors is typically 2-3 orders of magnitude, for the purposes of this description, in the unlikely event that a person of ordinary skill in the art would be unable to distinguish conductors from insulators, insulators will arbitrarily be considered to have a thermal conductivity of less than 1 W/mK, and conductors will be considered to be materials having a thermal conductivity of more than 1 W/mK.

Referring to the Figures, and by way of a general overview, a window assembly is indicated generally as 20. Window assembly 20 may be used as a widow in a wall, or it may be used as a window in a door. Window assembly 20 may include a first, or inside, surround, or bezel, or frame assembly 22; a second, or outside, surround, or bezel, or frame assembly 24; and a panel assembly 26 carried by, and typically bracketed by, or sandwiched by, the inside and outside assemblies 22, 24. When the sandwich is formed, the inside frame and the outside frame may be held in place with one or more connectors 30.

In the most generic sense, panel assembly 26 may be any kind of panel. However, in the context of the present invention, panel assembly 26 may most typically have the form of a planar, or substantially planar sheet, and may most typically be glazing such as may be identified generically as a window pane 28, whether clear (i.e., transparent) or frosted (translucent); whether single pane or multi-pane; whether sealed or unsealed; whether plain or patterned or coloured or decorative in the form of a stained glass assembly or similar.

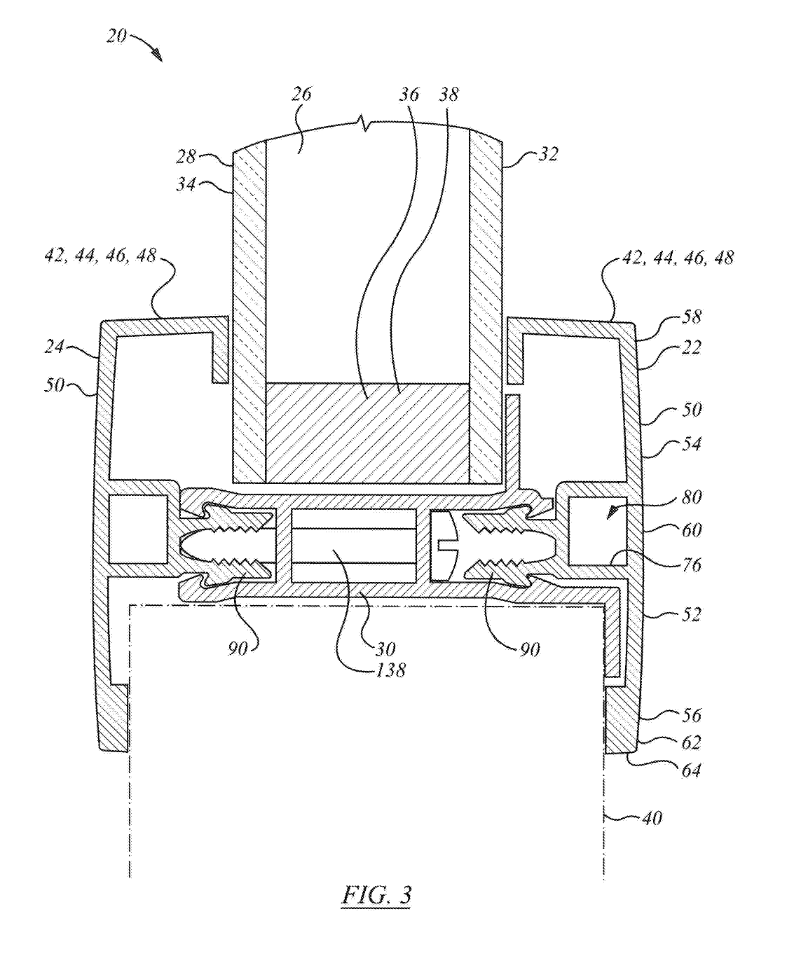

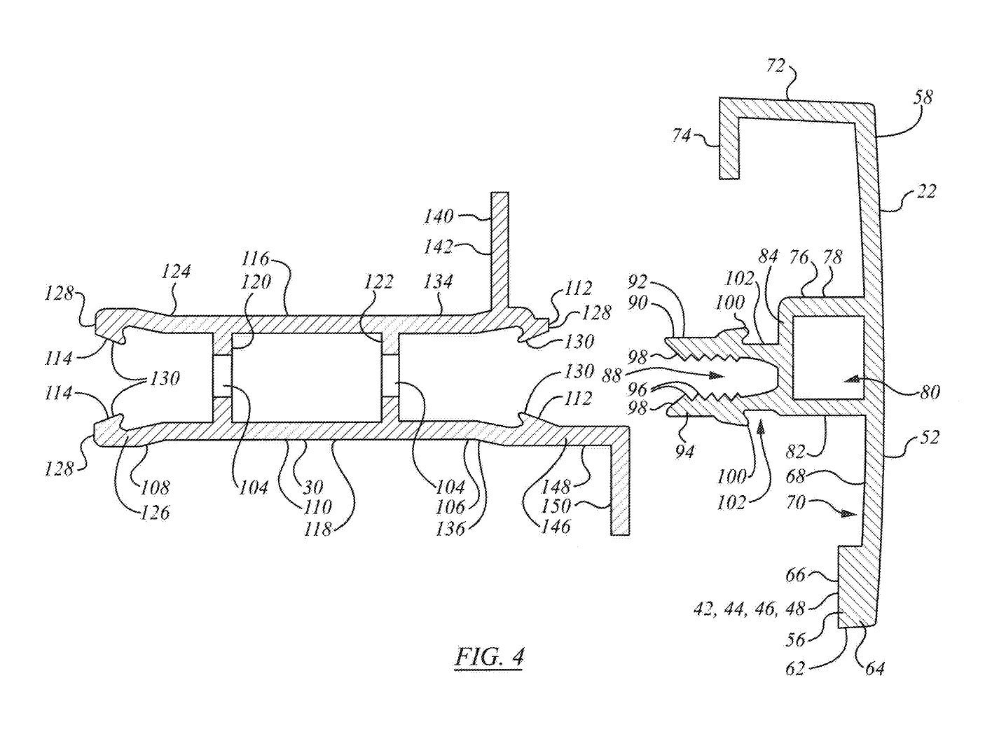

While round, or oval, or triangular or trapezoidal planform window shapes are known, for the purposes of this description, and in most common use, window assembly 20 and panel assembly 26 in particular may be taken as being four-sided, most typically rectangular panel elements. Often, though not always, the rectangular form may have a long dimension that is the vertical dimension on installation, corresponding to the z-axis or z-direction in this description. Window assembly 20 and panel assembly 26 may also have a shorter dimension that may be the width dimension on installation running in the y-axis or y-direction. The entire assembly may have a through thickness in the x-direction. The entire window assembly may be predominantly or substantially planar in the sense that the y-direction and z-direction extent of the structure may typically be many times the through-thickness dimension in the x-direction. The entire assembly may be mounted in surrounding structure, suggested by the intermittent dashed line in FIG. 3, such as in a wall (or door), and notionally indicated as 40.

For the purposes of the present description, panel assembly 26 will be considered to be transparent glazing that includes a first sheet of glazing, identified as first pane 32, a second pane of glazing identified as second pane 34, and a third member 36 which may have the form or function of a spacer or standoff, 38, such as may be located between first pane 32 and second pane 34. Panes 32 and 34, and third member 36 may be sealed about their common periphery to form a sealed multi-pane window panel. Although a double pane is shown, the window may also be a triple pane window. The window panel may also be provided with coatings to reduce glare or heat transfer, as may be.

First frame 22 may have top and bottom portions 42, 44 that run predominantly cross-wise (i.e., in the width-wise or y-direction on installation), and left and right hand side portions 46, 48 that run predominantly up-and-down (i.e., in the vertical or z-direction on installation) and that co-operate to form the generally rectangular shape or frame of window assembly 20 generally. The elements of the assembly, namely portions 42, 44, 46 and 48, may all have the same cross-sectional profile, and may be made as extruded members. It may be that portions 42, 44, 46, and 48 may be made of an extruded material, such as aluminum, or a plastic. The various corner pairs may be mitered to fit together, and may be secured using corner keys, welding, PVC welding, glues, bonding agents or like materials.

Second, or outside, frame assembly 24 may be identical to first, or inside, frame assembly 22, although this need not necessarily be so in the general case. For the purposes of simplification of this description, in the embodiment shown it will be taken that this is so. As such, a description of the cross-section of bottom portion 42 of first frame 22 may be taken as representative of all of the members of first frame 22 and second frame 24.

The cross-section of bottom portion 42 is shown in FIG. 3. The extrusion is identified generally as 50. It has a first wall, or member 52 that can be thought of as the facing of the item. That is, the exterior surface 54 of member 52 faces away from the window pane, and provides the presentation surface most visible to persons facing the window. It can be considered, and is, a “trim panel”. Member 52 has a first end, 56, a second end 58, and a medial portion 60.

First end 56 is the bottom end in FIG. 3, and, in use is the end most distant from the window pane. It is the end that laps over the adjacent wall or door structure, shown in an intermittent line and indicated notionally as 40. At the first end 56 member 52 may terminate in a foot 62 that may have the form of a doubling, or flange, or bulbous end, or thickened end 64, as may be, that is fattened to provide an index, or datum, or stop, or abutment, surface 66 that may bear against, e.g., a wood panel, or drywall, of a door face, of the surrounding structure. On the inward (or wall-facing, or back) face 68 of member 52 there may be a space, or alcove, or chamber, or rebate, or relief, or seat, or accommodation 70, however it may be termed, that accommodation having a depth equal to or greater than the distance by which thickened end 64 stand inwardly proud of inward surface 68.

Second end 58 of member 52 is the top end in FIG. 3, and it is the end most proximate to the window pane. It may include an arm or leg, or finger, or flange, in the form of a member 72 that extends substantially horizontally from member 52 back toward the window pane, and that forms the visible or cosmetic edge or sill of the window. Member 72 may also have a further portion or flange 74 that is folded downwardly to form a surface facing in planar opposition to panel assembly 26.

Medial portion 60 extends between first and second end portions 56 and 58. In an intermediate location, which may be roughly half way between ends 56 and 58, medial portion 60 has a closed-section member 76 that may be generally square or rectangular. Member 76 has first and second, upper and lower, webs 78, 82 that stand generally perpendicularly to, and away from, member 52; and a fourth wall 84, a closing wall, spaced generally parallel to, and away from, member 52 that completes the closed periphery of the rectangular section. The hollow 80 defined therewithin may be the hollow for receiving a corner key for assembly of four such members into a rectangular frame.

The structure described so far may be considered conceptually as a beam in which the main web is member 52, member 72 (and finger 74) define a re-entrant top flange, and foot 62 forms a bottom flange, with predominant resistance to bending in the plane parallel to the main surface of panel assembly 26. It also describes a beam with non-trivial depth in the through-thickness direction of panel 26.

It may be noted that a connector engagement member, or structure, or socket, or prong, or connection fitting, identified generally as a connector 90 extends inwardly from closed section member 76 away from member 52. Connector 90 may be a male connector or a female connector. It may include a pair of legs 92, 94 that are spaced apart and that extend away from closed section member 76. Legs 92 and 94 may be symmetrical. That is to say, they may be mirror images of each other such that, together, they form a co-operating pair, and, collectively, form connector 90.

Each of the legs 92 and 94, or both legs taken together, may be referred to as a prong or prongs. The two legs may define between them an accommodation 88. The inside faces of legs 92, 94, that is, the sides of legs 92, 94 that are opposed and therefore facing generally toward each other to define the sides of accommodation 88, may be provided with ridges, or threads, or asperities, or teeth 96. The inside faces of legs 92, 94 may not be quite parallel, but are angled together toward their roots such that accommodation 88 is slightly narrowing toward its closed end. The end face, or tip, of each prong may be rounded or chamfered, as at 98, such as to provide a lead-in for an approaching engaging member. The outside face of each of legs 92, 94 may have a stop, or abutment, or barb, or catch 100, and, in the lee of the catch, a relief 102 for accommodating a mating feature of another member that may engage catch 100. Legs 92 and 94 may be rooted in the intermediate closed-periphery member 76.

Connector 30 may also be an extruded member. However, connector 30 may be made of something other than aluminum. That is, a plastic or composite material may be used that is a thermal insulator, such that the thermal conduction path between first frame 22 and second frame 24 is interrupted.

Connector 30 may have a first end, 106, a second end 108, and a medial portion 110 extending between the two ends. First end 106 has an engagement fitting (or fittings) 112 for engagement with the corresponding mating fitting, or fittings 92, 94, of connector 90 of the respective first frame member, be it 42, 44, 46 or 48. Similarly, second end 108 has an engagement fitting, or fittings, 114 for mating engagement with the corresponding fittings 92, 94 of the respective second frame member, be it 42, 44, 46 or 48.

Intermediate member or portion 110 may be a hollow form sections having first and second webs 116, 118 that in this instance extend in a plane parallel to the sealed edge of the window pane. First and second webs 116, 118 are maintained in spaced-apart parallel relationship by a pair of intermediate webs 120, 122. Intermittently, there may be a fastener bore 104 formed through webs 120, 122, as appropriate to admit a mechanical threaded fastener such as a screw 138. The rectangular box or frame defined by the combination of webs 116, 118, 120 and 122 may be considered to be the “body” of connector 30.

The second ends 124, 126 of webs 116, 118 extend beyond web 120. Each has a catch 130 formed thereat. Ends 124 and 126 are more flexible than aluminum, and thus when legs 92, 94 of second frame 24 are driven into engagement with ends 124, 126, those ends may tend to deflect as the tapered or rounded lead-ins of catch 100 and catch 130 ride against each other. Ends 124, 126 are resilient, and as they spring outward they become resiliently biased back toward their undeflected condition. This continues until the rearward facing abutments of catches 100 and 130 clear the lead-in slopes, and snap together, with the rearward-facing hooks of catches 100 and 130 snapping back into the respective accommodations formed as gullets or reliefs in the lee of those hooks. The engagement is a one-way engagement—once the abutment hooks have passed each other and engaged, the rearward facing tooth of each hook is impeded by the other hook from disengaging. They are now prevented from backing away from each other. In addition, catch 130 of end 124 has a stop 128 that will bottom against the back wall of fourth wall 84 of closed member 76 if pushed too far.

The first ends 134, 136 of webs 116, 118 are similar to, and have all of the same features as ends 124, 126, and likewise engage the prongs or legs 92, 94 of connector 90 of first frame 22. Further, a wing, or member, or arm, or index, or datum member, or stop, or abutment, or flange 140 that extends upwardly from a root near catch 130 of second end 134. Flange 140 extends away from catch 130 toward the sealed window pane. On installation, the rearward face of flange 140, facing toward web 122, bears against panel assembly 26, and locates, connector 30 relative to panel assembly 26. Once so located, mechanical fastener 138 may be driven through webs 122 and 120 of connector 30 and into front frame assembly 24 and tightened, and in so doing works against teeth 96, causing legs 92, 94 to bind, and abutments or stops 128 to bottom out against member 84, thus capturing window panel 26 between flange 140 and finger 74 of frame 24. Fasteners 138 need not be made of steel. They could be made of a hard plastic or composite material. A composite material may tend not to provide a thermally conductive path. They need not be overly tightened. The threads may be treated with a bonding agent, epoxy, or glue.

Furthermore, connector 30 has another index, or stop, or abutment, or bracket, or arm, or locator member, or extension, or appendage 146. Appendage 146 may include a member or leg 148 that extends longitudinally from catch 130 of end 136 of web 118 toward medial portion 60. Appendage 146 may also include a flange 150 that extends transversely from leg 148. Flange 150 may extend generally parallel to the plane of window pane 28, and, on assembly, may define a foot that provides a back-stop or buffer for first frame 22 on window pane 28. That is, flange 150 may seat in accommodation 70, in opposition to the inside surface 66 of member 52. As seated, the rearward face of flange 150 may lie flush with face 66 of foot 62. On installation of window assembly 20 in a wall structure 40, the back face of flange 150 may then lie against wall structure or door surface 40. Since each member 42, 44, 46 and 48 includes one or more connectors 30, their respective flanges 150 may define a footprint, or bezel, or surround that positively locates connectors 30, and therefore pane 28, at a set depth relative to the inside surface, typically drywall, of the structure. That is, the rear face of flange 150 defines a datum, or index reference point when it seats against the surrounding wall structure, thereby locating the glass element depth, i.e., as per the difference in the x-direction between the first datum and the second datum. That is, the connector defines three relationships: (1) the location of the window pane relative to the first frame; (2) the location of the window pane relative to the supporting wall structure; and (3) the connection of the first and second frames in a single assembly. It may be noted that once the connector is in place, the addition of the inside frame is not structurally necessary, and it is in some sense cosmetic.

Connector 30 may be a continuous extrusion of a length corresponding to, but somewhat less than members 42, 44, 46 and 48, or may be provided in discrete, shorter sections, like cleats, that may be 2″-4″ long, for example.

On assembly, second frame member 24 is placed on a flat horizontal surface, such as a table. A bead of sealant, or a gasket, or O-ring seal, or a double-sided adhesive tape, may be provided to flange 74 of second frame member 24, as may be appropriate. Window pane assembly 28 is then placed on second frame member 24, in a generally centered position. Connectors 30 are installed in members 42, 44, 46 and 48. In each case the hooks of catches 130 of fittings 114 of second end 108 engage the respective hooks of catches 100 of connector 90 of the other member. Threaded fasteners 138 are installed and gently tightened until snug. This will trap window pane assembly 28 between the first index, flange 140 of connector 30, and flange 74 of frame member 24. The unit may be installed in the window opening in structure 40 in this condition. Finally, first frame member 22 is placed on top. Connectors 90 of member 22 engage fittings 112 of connectors 30, such that flange 74 of the various members of frame member 22 face, and may lie against, window pane assembly 28. As before, a seal may be provided between flange 74 and the glazing sheet, 32 of pane assembly 28. Flange 150 seats in accommodation 70, flush on the inside face with foot 62. The window panel is then bracketed by the inside and outside wings, namely ends 56, of the inside and outside framing extrusions.

The embodiments illustrated and described above illustrate individual non-limiting examples in which the principles of the present invention are employed. It is possible to make other embodiments that employ the principles of the invention and that fall within the following claims. To the extent that the features of those examples are not mutually exclusive of each other, the features of the various embodiments may be mixed-and-matched, i.e., combined, in such manner as may be appropriate, without having to resort to repetitive description of those features in respect of each possible combination or permutation. The invention is not limited to the specific examples or details which are given by way of illustration herein, but only by the claims, as mandated by law. The claims are to be given the benefit of purposive interpretation to include equivalents under the doctrine of equivalents.

As described above, there is a window assembly securement, namely connector 30. It has, or is, a body or frame, or hollow section, having a first end and a second end. The first end has a first frame engagement, namely fitting, or fittings, 112. The second end has a second frame engagement, namely fitting or fittings, 114. There is a first index mounted to the body near the first end, namely index 140. Index 140 defines an abutment against which to locate a window, such as window pane 28, such as may be a glass pane or pane, that window then being sandwiched between the first index and the first frame. Index 140 thereby fixes the position of the glass pane, or pane, relative to the outside frame 24.

The body may also have another index, namely member 146, which includes flange 150. This second index is also mounted to the first end of connector 30. Flange 150 of member 146 defines an abutment against which to seat the window assembly against adjacent structure, such that the window assembly is secured on, or to, the surrounding structure by sandwiching or bracketing the surrounding structure between the second index and the second fame 24. The securement of either or both of first frame engagement 112 and second frame engagement 114 may include a one-way motion catch in the form of catch 112 or 114 (or a pair of opposed co-operating catches 112, or 114, as may be). These catches may have the form of a hook or hooks that engage the mating member, or members, of one of the window frames. Either of frame engagements 112 and 114 may be, or may include, a spring biased deflection member. Connector 30 may have a fastener accommodation passing therethrough, such as bore 104 for receiving fastener 138.

Connector 30 may be an extrusion. Connector 30 may be a thermal insulator. Connector 30 may be made of a material having a co-efficient of thermal conductivity, k, that is less than 1 W/mK, such as a plastic.

In the description, window frame assembly 20 has a first window frame member 22; a second window frame member 24; and a connector 30. Connector 30 has a first end and a second end. First widow frame member 22 has a first fitting 90, that is matingly engageable with the first end of connector 30. Second window frame member 24 has a second fitting 90, that is matingly engageable with the second end of connector 30. Connector 30 is made of a thermal insulator material. When window 20 is assembled, connector 30 is positioned between first and second frame members 22, 24, and in which first and second frame members 22, 24 bracket a window pane 28. First and second window frame members 22, 24 are formed of material, such as aluminum, that is more highly thermally conductive than the thermal insulator material of connector 30. Alternatively one, the other, or both, could be made of PVC. One of all of members 22, 24 and 30 may be an extrusion. Either or both of member 22, 24 may be made of aluminum. Either, or both, of members 22, 24 may have a wing that, on installation, conceals a margin of the window pane. Members 22, 24 may have the same cross-section.

Connector 30 has a first index 140. Index 140 defines an abutment against which to seat window pane 28. The abutment is in opposition to second window frame member 24, whereby window pane 28 is located between index 140 and first window frame member 22.

The window frame assembly 20 has a first wing, item 54, on the first frame assembly 22, and a second wing, item 54 on the second frame assembly 24. On assembly the two wings 54 are faced to oppose each other, and the window panel is captured between the respective wings of the first and second frame members. The connector has a first index, and said first index defines an abutment. On assembly, the abutment stands in opposition to the first frame member whereby the second frame member is fixedly located relative to the connector. The connector has a second index. The second index defines an abutment; and, on assembly, that abutment stands in opposition to the second frame member whereby the second frame member is positioned relative to the connector.

The first frame member and the first end of the connector have mutually engaging end fittings, those fittings being male on one hand, and female on the other, and being one-way spring-biased snap-fit on assembly. The second frame member and second end of the connector have mutually engaging end fittings, being male on one hand, and female on the other, and being one-way spring-biased snap-fit on assembly. The end fitting of the second window frame connector has flights to engage a threaded fastener; and the connector accommodates the passage of a threaded fastener to engage those flights, such engagement causing the second end fitting of the connector and the end fitting of said second window frame member to bind.

Although the various embodiments have been illustrated and described herein, the principles of the present invention are not limited to these specific examples which are given by way of illustration, but only by a purposive reading of the claims.

I claim:

1. A window assembly securement comprising:
a body having a first end and a second end;
the first end having a first frame engagement by which said body is mounted to a first window frame member;
said second end having a second frame engagement; and
a first index mounted to said body, said first index defining an abutment against which to locate a window pane, said index thereby fixing the position of the window pane relative to the second frame.

2. The securement of claim 1 wherein said body has a second index, said second index being mounted to said first end, said second index defining an abutment to seat against supporting structure to which the window assembly is mounted, said second index thereby functioning as a datum fixing the position of the window relative to the supporting structure.

3. The securement of claim 1 wherein said securement is a thermal insulator.

4. The securement of claim 1 wherein at least one of said first frame engagement and said second frame engagement is a one-way motion catch.

5. The securement of any one of claims 1 to 3 wherein said first frame engagement is a one-way catch and said second frame engagement is a one-way catch.

6. The securement of claim 1 wherein said securement has a fastener accommodation passing therethrough.

7. The securement of any one of claims 1 to 6 wherein said securement is an extrusion.

8. The securement of any one of claims 1 to 7 wherein at least one of said first frame engagement and said second frame engagement is a spring biased deflection member.

9. The securement of any one of claims 1 to 8 wherein said connector is made of a material having a co-efficient of thermal conductivity, k, that is less than 1 W/mK.

10. A window assembly, comprising:
a first window frame member; a second window frame member; and a connector;
said connector having a first end and a second end;
said first widow frame member having a first fitting, said first fitting being matingly engageable with said first end of said connector;
said second window frame member having a second fitting, said second fitting being matingly engageable with said second end of said connector;
said connector being made of a thermal insulator material; and
when assembled said connector is positioned between said first and second frame members, and said first and second frame members bracket a window pane.

11. The window assembly of claim 10 wherein said first and second window frame members are formed of material that is more highly thermally conductive than said thermal insulator material of said connector.

12. The window assembly of claim 10, wherein at least one of said first and second window frame members is an extrusion.

13. The window frame assembly of any one of claims 10 to 12 wherein at least one of said window frame members is made of aluminum.

14. The window frame assembly of any one of claims 10 to 13 wherein at least one of said window frame members has a wing that, on installation, conceals a margin of the window pane.

15. The window frame assembly of any one of claims 10 to 14 wherein said first window frame member and said second window frame member have the same cross-section.

16. The window frame assembly of any one of claims 10 to 15 wherein said connector has a first index, said first index defining an abutment against which to seat said window pane, said abutment being opposed to said second window frame member, whereby said window pane is located between said first index and said second window frame member.

17. The window frame assembly of claim 16 wherein said first window frame assembly has a first wing, and said second window frame assembly has a second wing; on assembly said first wing is faced to oppose said second wing, and said window pane is captured between said first and second wings of the first and second window frames respectively.

18. The window frame assembly of claim 17 wherein, on assembly, said first wing of said first window frame member and said first index are positioned flush with each other.

19. The window frame assembly of any one of claims 10 to 15 wherein said connector has a first index, and said first index defining an abutment; and, on assembly, said abutment stands in opposition to said second frame member whereby said first frame member is fixedly located relative to said connector.

20. The window frame assembly of claim 16 wherein said connector has a second index, said second index defining an abutment; and, on assembly, said abutment of said second index stands in opposition to said second frame member whereby said first frame member is positioned relative to said connector.

21. The window frame assembly of any of claims 10 to 20 wherein at least one of:
(a) said first frame member and said first end of said connector have mutually engaging end fittings, said end fittings being male on one hand, and female on the other, and being one-way spring-biased snap-fit on assembly;
(b) said second frame member and said second end of said connector have mutually engaging end fittings, said end fittings being male on one hand, and female on the other, and being one-way spring-biased snap-fit on assembly.

22. The window frame assembly of claim 21 wherein said end fitting of said second window frame connector has flights for engagement of a threaded fastener; and said connector accommodates the passage of a threaded fastener therethrough to engage said flights, such engagement causing said second end fitting of said connector and said end fitting of said second window frame member to bind.
